(19) United States
(12) Patent Application Publication
(10) Pub. No.: US 2026/0064986 A1
(43) Pub. Date: Mar. 5, 2026

(54) CHAT CONTROL SYSTEM, CHAT CONTROL METHOD, AND INFORMATION STORAGE MEDIUM

(71) Applicant: Rakuten Group, Inc., Tokyo (JP)

(72) Inventors: Tu Tuan TRAN, Tokyo (JP); Minh The NGUYEN, Tokyo (JP)

(21) Appl. No.: 19/308,352

(22) Filed: Aug. 25, 2025

(30) Foreign Application Priority Data
Aug. 27, 2024 (JP) 2024-145713

(51) Int. Cl. G06F 40/40; H04L 51/21

(52) U.S. Cl. CPC G06F 40/40; H04L 51/21

(57) ABSTRACT

A determination and generation processing execution module executes determination and generation processing for each piece of non-generated required information. A determination and generation control module causes, when at least one of the pieces of non-generated required information is not generated based on a chat message, in response to reception of a next chat message from a user terminal, the determination and generation processing execution module to execute the determination and generation processing for the next chat message. A prompt generation module generates, when all of the pieces of non-generated required information are generated based on the chat message, a prompt based on the plurality of pieces of required information.

### CROSS-REFERENCE TO RELATED APPLICATION

The present application claims priority from Japanese application JP2024-145713 filed on Aug. 27, 2024, the content of which is hereby incorporated by reference into this application.

### BACKGROUND OF THE INVENTION

### 1. Field of the Invention

The present invention relates to a chat control system, a chat control method, and an information storage medium.

### 2. Description of Related Art

In recent years, a technology which makes use of a large language model (LLM) has been attracting attention. As an example of this technology, in Japanese Patent Translation Publication No. 2024-521053, there is described a technology which uses an LLM in generating an automated assistant response.

### SUMMARY OF THE INVENTION

The user repeats output of a prompt to the LLM and reception of an answer from the LLM, to thereby be able to acquire information in an interactive manner.

However, when information required for providing an appropriate answer to the prompt is not input to the LLM, the LLM sometimes provides an inappropriate answer such as a vague answer or an irrelevant answer to the prompt.

The present disclosure addresses the above-mentioned problem, and provides a chat control system, a chat control method, and an information storage medium with which it is possible to increase a possibility of acquiring, from an LLM, an appropriate answer to a prompt while enabling a user to acquire information interactively.

(1) A chat control system according to at least one embodiment of the present invention includes: determination and generation processing execution means for executing determination and generation processing of determining, in response to reception of a chat message from a terminal being a communication partner of the chat message, whether generation of each piece of non-generated required information out of a given plurality of pieces of required information based on the chat message is possible, and generating, based on the chat message, required information, the generation of which is determined to be possible; determination and generation control means for causing the determination and generation processing execution means to execute the determination and generation processing for a next chat message in response to reception of the next chat message from the terminal when at least one of the pieces of non-generated required information is not generated based on the chat message; prompt generation means for generating a prompt based on the given plurality of pieces of required information when all of the pieces of non-generated required information are generated based on the chat message; prompt output means for outputting the prompt to a large language model; answer reception means for receiving an answer to the prompt from the large language model; and chat message output means for outputting, to the terminal, a chat message based on the received answer.

(2) The chat control system according to the above-mentioned item (1) may further include inquiry message output means for outputting, when at least one of the pieces of non-generated required information is not generated based on the chat message, a chat message for inquiring required information yet generated, to the terminal.

(3) In the chat control system according to the above-mentioned item (2), the determination and generation processing execution means may generate, when, based on a chat message received from the terminal in response to the chat message for inquiring about the required information yet generated, generation of another piece of required information different from the required information is determined to be possible, the other piece of required information based on the chat message.

(4) The chat control system according to any one of the above-mentioned items (1) to (3) may further include log determination and generation means for determining, in response to reception of a chat message for requesting an answer from the large language model from the terminal, whether the generation of each of the given plurality of pieces of required information is possible based on a log of the chat message in communication to and from the terminal, and generating, based on the log, the required information the generation of which is determined to be possible, the determination and generation control means may cause the determination and generation processing execution means to execute, when at least one of the given plurality of pieces of required information is not generated based on the log, in response to reception of a next chat message from the terminal, the determination and generation processing for the next chat message, and the prompt generation means may generate, when all of pieces of required information are generated based on the log, a prompt based on the given plurality of pieces of required information.

(5) In the chat control system according to any one of the above-mentioned items (1) to (4), the determination and generation processing execution means may generate, when generation of a plurality of pieces of required information based on one chat message is determined to be possible, the plurality of pieces of required information based on the one chat message.

(6) A chat control method according to at least one embodiment of the present invention includes the steps of: executing determination and generation processing of determining, in response to reception of a chat message from a terminal being a communication partner of the chat message, whether generation of each piece of non-generated required information out of a given plurality of pieces of required information based on the chat message is possible, and generating, based on the chat message, required information, the generation of which is determined to be possible; executing the determination and generation processing for a next chat message in response to reception of the next chat message from the terminal when at least one of the pieces of non-generated required information is not generated based on the chat message; generating a prompt based on the given plurality of pieces of required information when all of the pieces of non-generated required information are generated based on the chat message; outputting the prompt to a large language model; receiving an answer to the prompt from the large language model; and outputting, to the terminal, a chat message based on the received answer.

(7) An information storage medium according to at least one embodiment of the present invention is a non-transitory computer readable information storage medium storing a program that causes a computer to execute the steps of: executing determination and generation processing of determining, in response to reception of a chat message from a terminal being a communication partner of the chat message, whether generation of each piece of non-generated required information out of a given plurality of pieces of required information based on the chat message is possible, and generating, based on the chat message, required information, the generation of which is determined to be possible; executing the determination and generation processing for a next chat message in response to reception of the next chat message from the terminal when at least one of the pieces of non-generated required information is not generated based on the chat message; generating a prompt based on the given plurality of pieces of required information when all of the pieces of non-generated required information are generated based on the chat message; outputting the prompt to a large language model; receiving an answer to the prompt from the large language model; and outputting, to the terminal, a chat message based on the received answer.

### BRIEF DESCRIPTION OF THE DRAWINGS

FIG. 1 is a diagram for illustrating an example of a configuration of a chat system in at least one embodiment of the present invention.

FIG. 2 is a functional block diagram for illustrating an example of functions of an intermediate agent system in the at least one embodiment of the present invention.

FIG. 3 is a table for showing an example of required information.

FIG. 4 is a table for showing an example of the required information.

FIG. 5 is a table for showing an example of required information management data.

FIG. 6A is a flowchart for illustrating an example of a flow of processing executed in the intermediate agent system in the at least one embodiment of the present invention.

FIG. 6B is a flowchart for illustrating the example of the flow of the processing executed in the intermediate agent system in the at least one embodiment of the present invention.

FIG. 6C is a flowchart for illustrating the example of the flow of the processing executed in the intermediate agent system in the at least one embodiment of the present invention.

FIG. 6D is a flowchart for illustrating the example of the flow of the processing executed in the intermediate agent system in the at least one embodiment of the present invention.

### DESCRIPTION OF THE EMBODIMENTS

Hereinafter, at least one embodiment of the present invention will be described in detail with reference to the drawings.

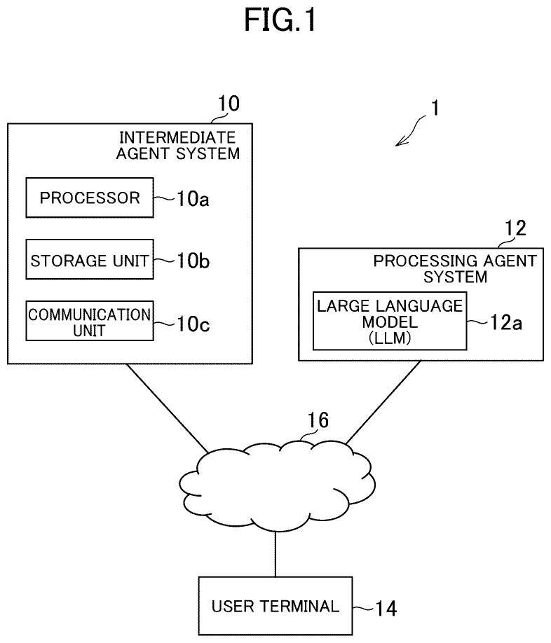

FIG. 1 is a diagram for illustrating an example of a configuration of a chat system 1 in the at least one embodiment of the present invention. As illustrated in FIG. 1, the chat system 1 in the at least one embodiment includes an intermediate agent system 10, a processing agent system 12, and a user terminal 14. The intermediate agent system 10, the processing agent system 12, and the user terminal 14 are connected to a computer network 16 such as the Internet.

The intermediate agent system 10 may be formed of a computer, for example, a server computer. The intermediate agent system 10 may include a processor 10a such as a CPU, a storage unit 10b such as a memory or a hard disk drive, and a communication unit 10c such as a network interface card. The intermediate agent system 10 may include a plurality of computers or one computer.

The processing agent system 12 may be formed of a server computer including, for example, a CPU, a GPU, a memory, and a communication interface. Moreover, the processing agent system 12 may include a plurality of computers or one computer. As illustrated in FIG. 1, in the processing agent system 12 in the at least one embodiment, a trained large language model (LLM) 12a is implemented.

The user terminal 14 may be formed of a computer (for example, a personal computer, a smartphone, or a tablet terminal) including, for example, a CPU, a memory, a communication interface, an input device, and a display.

In the at least one embodiment, communication of a chat message is executed between the intermediate agent system 10 and the user terminal 14. That is, in the at least one embodiment, for the intermediate agent system 10, the user terminal 14 corresponds to a terminal being a communication partner of the chat message. Moreover, in the at least one embodiment, the intermediate agent system 10 outputs a prompt to the LLM 12a included in the processing agent system 12 as required. Moreover, the intermediate agent system 10 generates a chat message based on an answer to the prompt from the LLM 12a, and outputs the generated chat message to the user terminal 14.

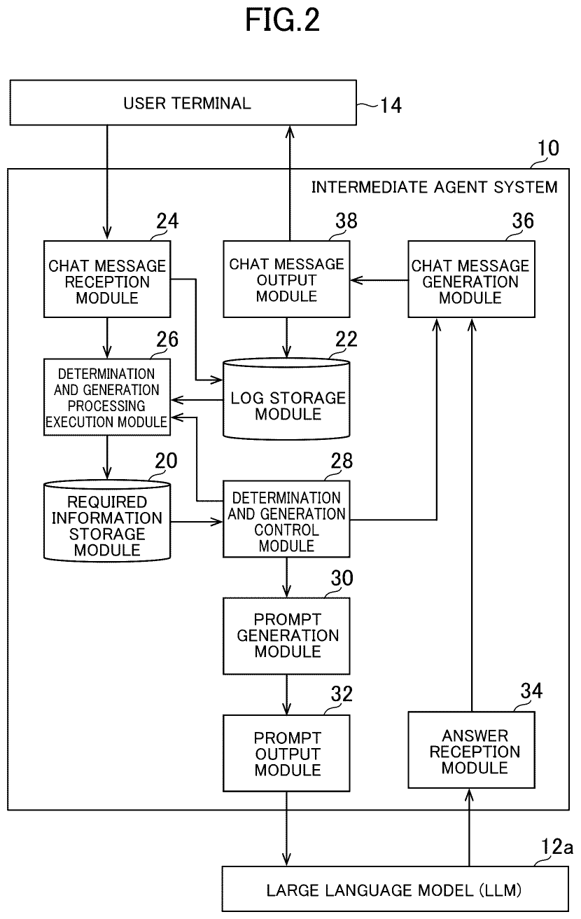

FIG. 2 is a functional block diagram for illustrating an example of functions implemented in the intermediate agent system 10 in the at least one embodiment. In the intermediate agent system 10 in the at least one embodiment, it is not required that all of the functions illustrated in FIG. 2 be implemented, and a function other than the functions illustrated in FIG. 2 may be implemented.

As illustrated in FIG. 2, the intermediate agent system 10 in the at least one embodiment functionally includes, for example, a required information storage module 20, a log storage module 22, a chat message reception module 24, a determination and generation processing execution module 26, a determination and generation control module 28, a prompt generation module 30, a prompt output module 32, an answer reception module 34, a chat message generation module 36, and a chat message output module 38. The intermediate agent system 10 in the at least one embodiment plays a role as a chat control system which controls the chat executed in the chat system 1. The required information storage module 20 and the log storage module 22 are implemented mainly by the storage unit 10b. The chat message reception module 24, the prompt output module 32, the answer reception module 34, and the chat message output module 38 are implemented mainly by the communication unit 10c. The determination and generation processing execution module 26, the determination and generation control module 28, the prompt generation module 30, and the chat message generation module 36 are implemented mainly by the processor 10a.

The above-mentioned functions may be implemented by executing, in the intermediate agent system 10, a program installed on the intermediate agent system 10 being the computer, and including instructions corresponding to the above-mentioned functions. Moreover, the program may be supplied to the intermediate agent system 10 via a computer-readable information storage medium, for example, an optical disc, a magnetic disk, a magnetic tape, or a magneto-optical disk, or via the Internet or the like.

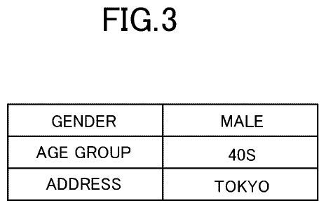

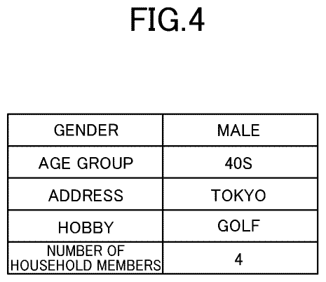

In the at least one embodiment, for example, the required information storage module 20 stores required information generated by the determination and generation processing execution module 26 described later. FIG. 3 and FIG. 4 are tables for showing examples of the required information. As shown in FIG. 3 and FIG. 4, the required information includes a combination of an index and a value. In FIG. 3, three pieces of required information are shown. In FIG. 4, five pieces of required information are shown.

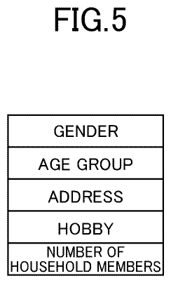

Moreover, in the required information storage module 20, required information management data shown in FIG. 5 may be stored in advance. The required information management data includes, for example, a list of indices of required information to be generated. Moreover, the required information management data may be referred to in determination and generation processing described later. In the required information management data shown in FIG. 5, five indices are indicated.

In the at least one embodiment, for example, the log storage module 22 stores a log of the chat messages in the communication between the intermediate agent system 10 and the user terminal 14. Here, for example, a chat message associated with a time stamp indicating a date and time at which the chat is received or output and a flag indicating whether the chat message is the chat message received by the intermediate agent system 10 or the chat message output by the intermediate agent system 10 may be accumulated in the log storage module 22.

In the at least one embodiment, for example, the chat message reception module 24 receives the chat message from the user terminal 14. Moreover, in the at least one embodiment, for example, the chat message reception module 24 stores the chat message in the log storage module 22.

In the at least one embodiment, for example, the determination and generation processing execution module 26 executes the determination and generation processing of determining, in response to reception of the chat message from the user terminal 14, whether or not generation of each piece of non-generated required information out of a given plurality of pieces of required information based on the chat message is possible, and generating, based on the chat message, the required information the generation of which is determined to be possible. Then, in the at least one embodiment, for example, the determination and generation processing execution module 26 stores the generated required information in the required information storage module 20. The determination and generation processing execution module 26 may be triggered by reception of a chat message (hereinafter referred to as “answer request message”) requesting an answer from the LLM 12a, such as “Tell me recommended products,” by the chat message reception module 24 to start the execution of the determination and generation processing.

Here, the determination and generation processing execution module 26 may identify non-generated required information based on the required information management data and generated required information. Then, the determination and generation processing execution module 26 may use a publicly-known natural language processing technology, for example, a name identification technology, a topic modeling technology, or an estimation technology that uses a trained machine learning model, to determine whether or not each of the pieces of required information identified not to have been generated can be generated based on the received chat message. Further, the determination and generation processing execution module 26 may generate the required information the generation of which is determined to be possible. Moreover, the determination and generation processing execution module 26 may output the generated required information to the required information storage module 20.

In the at least one embodiment, for example, no required information is stored in the required information storage module 20 in an initial state. In response to the generation of the required information in the determination and generation processing, the generated required information is successively accumulated in the required information storage module 20.

In the at least one embodiment, for example, the determination and generation control module 28 causes, when at least one of the pieces of non-generated required information is not generated based on the chat message, the determination and generation processing execution module 26 to execute, in response to reception of a next chat message from the user terminal 14, the determination and generation processing for the next chat message. Here, for example, the determination and generation control module 28 may output an instruction to execute the determination and generation processing for the next chat message to the determination and generation processing execution module 26 when at least one of the pieces of non-generated required information is not generated based on the chat message. Moreover, the determination and generation control module 28 may output, when at least one of the pieces of non-generated required information is not generated based on the chat message, to the chat message generation module 36, an instruction to generate a chat message for inquiring the non-generated required information.

Moreover, the determination and generation control module 28 may output an instruction to generate the prompt to the prompt generation module 30 when all of the pieces of non-generated required information are generated based on the chat message.

In the at least one embodiment, as described above, no required information is stored in the required information storage module 20 in the initial state. In this situation, the determination and generation processing execution module 26 identifies, based on the required information management data shown in FIG. 5, that five pieces of required information are not generated. Then, the determination and generation processing execution module 26 determines, based on the received chat message, whether or not it is possible to generate required information having “gender” in the index, required information having “age group” in the index, required information having “address” in the index, required information having “hobby” in the index, and required information having “number of household members” in the index.

Here, for example, it is assumed that the generation of the required information having “gender” in the index, the required information having “age group” in the index, and the required information having “address” in the index is determined to be possible. In this case, the three pieces of required information shown in FIG. 3 are generated, and those three pieces of required information are stored in the required information storage module 20. As described above, the determination and generation processing execution module 26 may generate, when the generation of a plurality of pieces of required information based on one chat message is determined to be possible, the plurality of pieces of required information based on the chat message.

In this case, the determination and generation control module 28 causes, in response to reception of a next chat message from the user terminal 14, the determination and generation processing execution module 26 to execute the determination and generation processing for the next chat message.

After that, the determination and generation processing execution module 26 identifies, based on the required information management data shown in FIG. 5 and the three pieces of generated required information, the two pieces of required information as the non-generated information. Then, the determination and generation processing execution module 26 determines whether or not the required information having “hobby” in the index and the required information having “number of household members” in the index can be generated based on the chat message received next.

Here, for example, it is assumed that the generation of the required information having “hobby” in the index and the required information having “number of household members” in the index is determined to be possible. In this case, the required information having “hobby” in the index and the required information having “number of household members” in the index are generated, and those two pieces of required information are stored in the required information storage module 20. As a result, the five pieces of required information shown in FIG. 4 are stored in the required information storage module 20.

In this case, the determination and generation control module 28 outputs the instruction to generate the prompt to the prompt generation module 30.

In the at least one embodiment, for example, the prompt generation module 30 generates, when all of the pieces of non-generated required information are generated based on the chat message, the prompt based on the given plurality of pieces of required information. The prompt generation module 30 may generate the prompt based on the given plurality of pieces of required information in response to the reception of the instruction to generate the prompt from the determination and generation control module 28. For example, in the situation in which the five pieces of required information shown in FIG. 4 are stored in the required information storage module 20, the prompt is generated based on those five pieces of required information.

Here, for example, the prompt generation module 30 may generate a prompt including a character string indicating the combination of the index and the value of the required information and a character string indicated by the above-mentioned answer request message (for example, “Tell me recommended products”).

In the at least one embodiment, for example, the prompt output module 32 outputs the prompt generated by the prompt generation module 30 to the LLM 12a.

In the at least one embodiment, for example, the answer reception module 34 receives an answer to the prompt output by the prompt output module 32 from the LLM 12a.

In the at least one embodiment, for example, the chat message generation module 36 generates the chat message to be output to the user terminal 14.

In the at least one embodiment, for example, the chat message output module 38 outputs the chat message generated by the chat message generation module 36 to the user terminal 14. Moreover, in the at least one embodiment, for example, the chat message output module 38 stores the chat message in the log storage module 22.

In the at least one embodiment, for example, when the answer reception module 34 receives an answer from the LLM 12a, the chat message generation module 36 may generate, in response to the reception of the answer, a chat message based on the answer. Here, a chat message including the answer may be generated. The chat message may be the same character string as that of the answer, or may be a character string different therefrom. For example, a chat message obtained by processing the answer (for example, obtained by translating the answer) may be generated. Then, the chat message output module 38 may output a chat message based on the answer to the user terminal 14.

Moreover, the chat message generation module 36 may generate, when at least one of the pieces of non-generated required information is not generated based on the chat message by the determination and generation processing execution module 26, a chat message for inquiring the required information yet generated. For example, the chat message generation module 36 may generate a chat message for inquiring the required information yet generated in response to the reception of the instruction to generate the chat message from the determination and generation control module 28. Then, the chat message output module 38 may output the chat message for inquiring the required information yet generated to the user terminal 14.

For example, as described above, it is assumed that the three pieces of required information shown in FIG. 3 are generated, but the required information having “hobby” in the index and the required information having “number of household members” in the index are not generated. In this case, for example, a chat message for inquiring the hobby of the user such as “What is your hobby?” may be generated, and the chat message may be output to the user terminal 14. Meanwhile, a chat message for inquiring the number of household members of the user such as “How many household members do you have?” may be generated, and the chat message may be output to the user terminal 14.

Here, for example, in response to the chat message “What is your hobby?” a chat message such as “My hobby is to play golf with my family members. My family has four members, including me.” with which the required information having “hobby” in the index and the required information having “number of household members” in the index can be generated may be received from the user terminal 14. In this case, the determination and generation processing execution module 26 may generate, based on the chat message received from the user terminal 14, both of the required information having “hobby” in the index and the required information having “number of household members” in the index.

As described above, the determination and generation processing execution module 26 may generate, when, based on the chat message received from the user terminal 14 in response to the chat message for inquiring the required information yet generated, the generation of another piece of required information different from the required information is determined to be possible, said another piece of required information based on the chat message.

In response to the chat message for inquiring the hobby of the user, a chat message from which the required information having “hobby” in the index cannot be generated but the required information having “number of household members” in the index can be generated may be received. In this case, the determination and generation processing execution module 26 may generate the required information having “number of household members” in the index based on the chat message received from the user terminal 14.

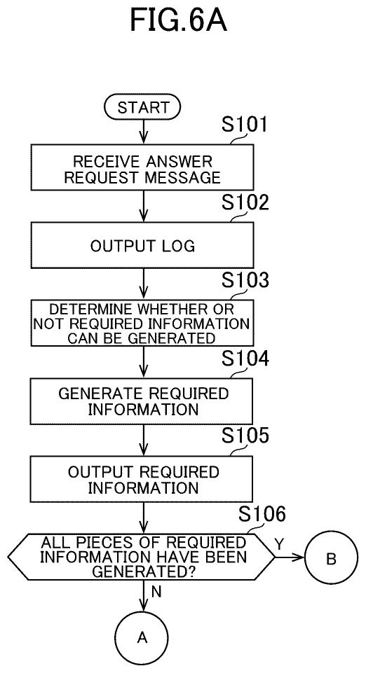

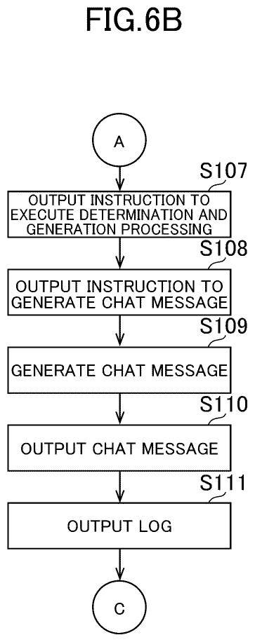

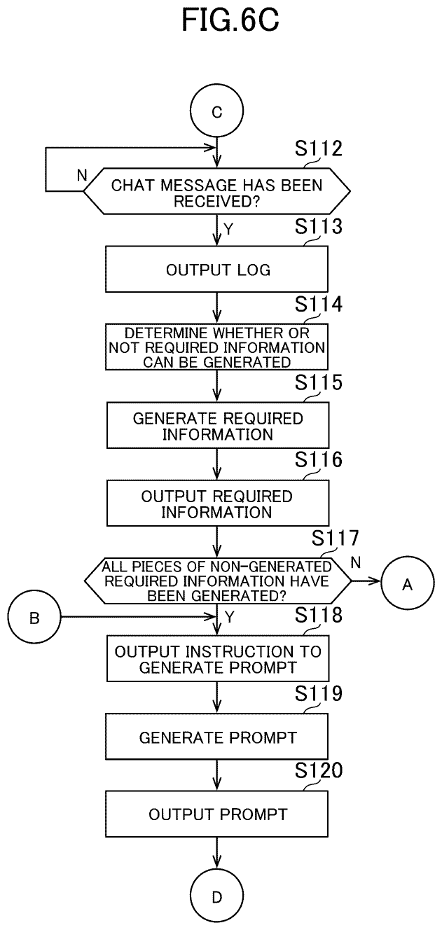

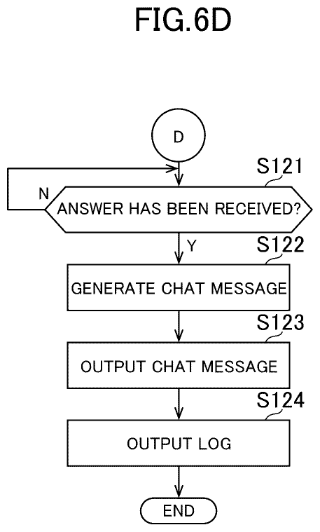

Here, with reference to a flowchart exemplified in FIG. 6A to FIG. 6D, description is given of an example of a flow of processing executed in the intermediate agent system 10 in the at least one embodiment.

In this processing example, it is assumed that the communication of the chat messages has been executed in advance between the intermediate agent system 10 and the user terminal 14. Moreover, it is assumed that the chat messages output from the intermediate agent system 10 to the user terminal 14 and the chat messages received by the intermediate agent system 10 from the user terminal 14 in the communication executed up to the current time have been accumulated as the log in the log storage module 22.

Description is now given of an example of processing to be executed in response to the reception of the answer request message by the chat message reception module 24 in the above-mentioned situation.

When the chat message reception module 24 receives the answer request message (Step S101), the chat message reception module 24 outputs the answer request message to the log storage module 22 (Step S102).

Then, the determination and generation processing execution module 26 determines whether or not it is possible to generate, based on the chat message received in the processing step of Step S101, each of the pieces of required information having the index indicated in the required information management data stored in the required information storage module 20 (Step S103).

Then, the determination and generation processing execution module 26 generates, based on the chat message received in the processing step of Step S101, the required information the generation of which is determined to be possible in the processing step of Step S103 (Step S104), and outputs the generated required information to the required information storage module 20 (Step S105). When there is no required information the generation of which is determined to be possible in the processing step of Step S103, the processing steps of Step S104 and Step S105 are not executed.

Then, the determination and generation control module 28 determines whether or not all of the pieces of required information have been generated in the processing step of Step S104 based on the required information management data and the required information stored in the required information storage module 20 (Step S106).

When it is confirmed that at least one of the pieces of required information having indices indicated in the required information management data has not been generated (N in Step 106), the determination and generation control module 28 outputs the instruction to execute the determination and generation processing for the next chat message to the determination and generation processing execution module 26 (Step S107), and outputs the instruction to generate the chat message for inquiring the required information yet generated to the chat message generation module 36 (Step S108).

Then, the chat message generation module 36 generates the chat message for inquiring the required information yet generated (Step S109). After that, the chat message output module 38 outputs, to the user terminal 14, the chat message generated in the processing step of Step S109 (Step S110), and outputs the chat message to the log storage module 22 (Step S111).

Then, the chat message reception module 24 waits for the reception of the next chat message (Step S112).

When the reception of the chat message is detected in the processing step of Step S112, the chat message reception module 24 outputs the chat message to the log storage module 22 (Step S113).

Then, the determination and generation processing execution module 26 determines whether or not it is possible to generate, based on the chat message the reception of which is detected in the processing step of Step S112, each of the pieces of non-generated required information identified based on the required information management data and the required information stored in the required information storage module 20 (Step S114).

Then, the determination and generation processing execution module 26 generates, based on the chat message the reception of which is detected in the processing step of Step S112, the required information the generation of which is determined to be possible in the processing step of Step S114 (Step S115), and outputs the generated required information to the required information storage module 20 (Step S116). When there is no required information the generation of which is determined to be possible in the processing step of Step S114, the processing steps of Step S115 and Step S116 are not executed.

Then, the determination and generation control module 28 determines whether or not all of the pieces of non-generated required information have been generated in the processing step of Step S115 based on the required information management data and the required information stored in the required information storage module 20 (Step S117).

When it is confirmed that at least one of the pieces of non-generated required information has not been generated (N in S117), the process returns to the processing step of Step S107, and Step S107 and the subsequent processing steps are again executed.

When it is confirmed that all of the pieces of required information having indices indicated in the required information management data have been generated in the processing step of Step S106 (Y in Step S106), or it is confirmed that all of the pieces of non-generated required information have been generated in the processing step of Step S117 (Y in Step S117), the determination and generation control module 28 outputs the instruction to generate the prompt to the prompt generation module 30 (Step S118).

Then, the prompt generation module 30 generates the prompt based on the plurality of pieces of required information stored in the required information storage module 20 (Step S119). After that, the prompt output module 32 outputs the prompt generated in the processing step of Step S119 to the LLM 12a (Step S120).

Then, the answer reception module 34 waits for the answer to the prompt from the LLM 12a (Step S121).

When the answer reception module 34 detects the reception of the answer, the chat message generation module 36 generates a chat message based on the answer (Step S122). Then, the chat message output module 38 outputs, to the user terminal 14, the chat message generated in the processing step of Step S122 (Step S123), and outputs the chat message to the log storage module 22 (Step S124), and the processing shown in this processing example is finished.

Even after the processing shown in this processing example is finished, the communication of the chat messages between the intermediate agent system 10 and the user terminal 14 continues.

In the at least one embodiment, the determination and generation processing execution module 26 may determine, in response to the reception of the answer request message from the user terminal 14, whether or not the generation of each of the given plurality of pieces of required information is possible based on the log of the chat messages in the communication to and from the user terminal 14, and may generate, based on the log, the required information the generation of which is determined to be possible. Then, the determination and generation control module 28 may cause, when at least one of those pieces of required information is not generated based on the log, in response to the reception of the next chat message from the user terminal 14, the determination and generation processing execution module 26 to execute the determination and generation processing for the next chat message. Meanwhile, when all of the pieces of required information are generated based on the log, the prompt generation module 30 may generate the prompt based on the plurality of pieces of required information.

For example, after the processing step of Step S102 is executed, without the execution of the processing steps of Step S103 to Step S105, the determination and generation processing execution module 26 may determine whether or not it is possible to generate, based on the log of the chat messages stored in the log storage module 22, each of the pieces of required information having the index indicated in the required information management data stored in the required information storage module 20. Then, the determination and generation processing execution module 26 may generate, based on the log stored in the log storage module 22, the required information the generation of which is determined to be possible, and may output the generated required information to the required information storage module 20. After that, Step S106 and the subsequent processing steps may be executed.

Moreover, the determination and generation processing execution module 26 may always execute the determination and generation processing, instead of being triggered by the reception of the answer request message to start the execution of the determination and generation processing.

Moreover, the LLM 12a may use information that none of the user terminal 14 and the intermediate agent system 10 can access to generate the answer.

In the at least one embodiment, as described above, only after all of the given plurality of pieces of required information are generated based on the chat messages, the prompt generated based on the plurality of pieces of required information is output to the LLM 12a.

Thus, the information required for providing an appropriate answer to the prompt is reliably provided to the LLM 12a, and hence it is possible to prevent the LLM 12a from providing an inappropriate answer such as a vague answer or an irrelevant answer to the prompt.

As described above, according to the at least one embodiment, it is possible to increase a possibility of the acquisition of an appropriate answer to the prompt from the LLM 12a while enabling the user to acquire information interactively.

The present invention is not limited to the above-mentioned at least one embodiment. For example, the required information storage module 20 may be provided to not the intermediate agent system 10, but a system different from the intermediate agent system 10. Moreover, for example, the log storage module 22 may be provided to not the intermediate agent system 10, but a system different from the intermediate agent system 10.

The above-mentioned specific character strings and numerical values and specific character strings and numerical values of the drawings are only exemplary, and the present invention is not limited to those character strings and numerical values.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A chat control system, comprising:
at least one processor; and
at least one memory device storing instructions which, when executed by the at least one processor, cause the at least one processor to perform operations comprising:
executing determination and generation processing of determining, in response to reception of a chat message from a terminal being a communication partner of the chat message, whether generation of each piece of non-generated required information out of a given plurality of pieces of required information based on the chat message is possible, and generating, based on the chat message, required information, the generation of which is determined to be possible;
executing the determination and generation processing for a next chat message in response to reception of the next chat message from the terminal when at least one of the pieces of non-generated required information is not generated based on the chat message;
generating a prompt based on the given plurality of pieces of required information when all of the pieces of non-generated required information are generated based on the chat message;
outputting the prompt to a large language model;
receiving an answer to the prompt from the large language model; and
outputting, to the terminal, a chat message based on the received answer.

2. The chat control system according to claim 1, wherein the operations further comprise:
outputting, when at least one of the pieces of non-generated required information is not generated based on the chat message, a chat message for inquiring required information yet generated, to the terminal.

3. The chat control system according to claim 2, wherein the executing of the determination and generation processing includes:
generating, when, based on a chat message received from the terminal in response to the chat message for inquiring about the required information yet generated, generation of another piece of required information different from the required information is determined to be possible, the other piece of required information being based on the chat message.

4. The chat control system according to claim 1,
wherein the operations further comprise:
determining, in response to reception of a chat message for requesting an answer from the large language model from the terminal, whether the generation of each of the given plurality of pieces of required information is possible based on a log of the chat message in communication to and from the terminal, and generating, based on the log, required information the generation of which is determined to be possible; and
executing, when at least one of the given plurality of pieces of required information is not generated based on the log, in response to reception of a next chat message from the terminal, the determination and generation processing for the next chat message, and
wherein the generating of the prompt includes generating, when all of pieces of required information are generated based on the log, a prompt based on the given plurality of pieces of required information.

5. The chat control system according to claim 1, wherein the executing of the determination and generation processing includes:
generating, when generation of a plurality of pieces of required information based on one chat message is determined to be possible, the plurality of pieces of required information based on the one chat message.

6. A chat control method, comprising:
executing determination and generation processing of determining, in response to reception of a chat message from a terminal being a communication partner of the chat message, whether generation of each piece of non-generated required information out of a given plurality of pieces of required information based on the chat message is possible, and generating, based on the chat message, required information, the generation of which is determined to be possible;
executing the determination and generation processing for a next chat message in response to reception of the next chat message from the terminal when at least one of the pieces of non-generated required information is not generated based on the chat message;
generating a prompt based on the given plurality of pieces of required information when all of the pieces of non-generated required information are generated based on the chat message;
outputting the prompt to a large language model;
receiving an answer to the prompt from the large language model; and
outputting, to the terminal, a chat message based on the received answer.

7. A non-transitory computer readable information storage medium storing a program that causes a computer to execute:
executing determination and generation processing of determining, in response to reception of a chat message from a terminal being a communication partner of the chat message, whether generation of each piece of non-generated required information out of a given plurality of pieces of required information based on the chat message is possible, and generating, based on the chat message, required information, the generation of which is determined to be possible;
executing the determination and generation processing for a next chat message in response to reception of the next chat message from the terminal when at least one of the pieces of non-generated required information is not generated based on the chat message;
generating a prompt based on the given plurality of pieces of required information when all of the pieces of non-generated required information are generated based on the chat message;
outputting the prompt to a large language model;
receiving an answer to the prompt from the large language model; and
outputting, to the terminal, a chat message based on the received answer.
